(19) United States
(12) Patent Application Publication
(10) Pub. No.: US 2008/0161102 A1
(43) Pub. Date: Jul. 3, 2008

(54) Non-risk gaming

(75) Inventor: Henry Von Kohorn, Vero Beach, FL (US)

Correspondence Address: HARRINGTON & SMITH, PC, 4 RESEARCH DRIVE, SHELTON, CT, 06484-6212, US

(73) Assignee: Response Reward Systems L.C.

(21) Appl. No.: 11/649,605

(22) Filed: Jan. 3, 2007

(51) Int. Cl. A63F 13/00

(52) U.S. Cl. 463/25

(57) ABSTRACT

A method for providing a wagering system regarding at least a partial result in at least one broadcast event. The method includes determining a prize payout amount for a winning wager based, at least partially, upon an audience rating of the broadcast event; and crediting the prize payout amount to an electronic account of a wagering party having the winning wager. The winning wager does not include a financial risk by the wagering party.

### BACKGROUND OF THE INVENTION

1. Field of the Invention

The invention relates to gaming and, more particularly, to a broadcast event and remote gaming relating to the broadcast event which does not include a financial risk by a wagering party.

2. Brief Description of Prior Developments

Internet gambling has come into existence in the past few years. However, government laws have now being enacted which can limit Internet gambling, such as by limiting transfer of funds to companies inside and outside the United States of America for Internet gambling purposes.

Gaming devices are known which allow a broadcast viewer to play along with a broadcast event, such as on a home handheld unit which allows a viewer to play “Wheel of Fortune” at home along with a broadcast event of the television show “Wheel of Fortune”.

Other reward systems for use in conjunction with broadcast events are also known, such as described in U.S. Pat. Nos. 5,034,807; 5,057,915; 5,283,734; and 5,713,795 for example, which are hereby incorporated by reference in their entireties.

There is a desire to provide a new type of gaming which will attract viewers to broadcast events by offering rewards, but without violating government gambling laws.

### SUMMARY OF THE INVENTION

In accordance with one aspect of the invention, a method for providing a wagering system regarding at least a partial result in at least one broadcast event is provided. The method includes determining a prize payout amount for a winning wager based, at least partially, upon an audience rating of the broadcast event; and crediting the prize payout amount to an electronic account of a wagering party having the winning wager. The winning wager does not include a financial risk by the wagering party.

In accordance with another aspect of the invention, a method of providing a wagering system regarding at least a partial result in at least one broadcast event is provided. The method comprising contracting by a broadcaster of the broadcast event with an advertiser for payment of a fee by the advertiser for broadcast of an advertisement by the broadcaster during the broadcast event, wherein an amount of the fee is determined, at least partially, based upon an audience rating of the broadcast event; receiving the payment of the fee from the advertiser at least partially after broadcast of the broadcast event; and allocating the fee to electronic accounts of wagering parties who placed a winning wager regarding the broadcast event.

In accordance with another aspect of the invention, a method of gaming is provided comprising entering a wager by a wagering party into an electronic communication device without a financial risk by the wagering party, wherein the wager is based, at least partially, upon an outcome of a broadcast event; and electronically communicating the wager to a broadcaster of the broadcast event.

In accordance with another aspect of the invention, a method of gaming is provided comprising providing a broadcast viewer an ability to wager regarding at least a partial result of at least one broadcast event, wherein the wager does not include a financial risk by the broadcast viewer; and depositing an electronic credit into an account for the broadcast viewer based upon a winning wager by the broadcast viewer.

### BRIEF DESCRIPTION OF THE DRAWINGS

The foregoing aspects and other features of the invention are explained in the following description, taken in connection with the accompanying drawings, wherein:

FIG. 1 is a diagram illustrating a conventional connection between a broadcaster and a broadcast viewer or listener;

FIG. 2 is a diagram illustrating a broadcast comprising features of the invention;

FIG. 3 is a diagram illustrating components for entry of a wager or gaming entry by a broadcast viewer;

FIG. 4 is a diagram illustrating steps which could be used to practice the invention;

FIG. 5 is a diagram illustrating components which can be used for determining an award amount for a winning wager; and

FIG. 6 is a diagram illustrating steps which can be performed in practicing features of the invention.

### DETAILED DESCRIPTION OF A PREFERRED EMBODIMENT

It should be understood that the term “event” is intended to include one or more events about to take place, taking place and/or past events which may have been recorded. For example, broadcast viewers may be asked to predict an outcome of a past event that may have taken place a number of years ago. To most viewers, the outcome of such a past event may not be remembered so that a prediction is similar to one made in the course of a current event. This could be used, for example, in a television or Internet game show type-of situation.

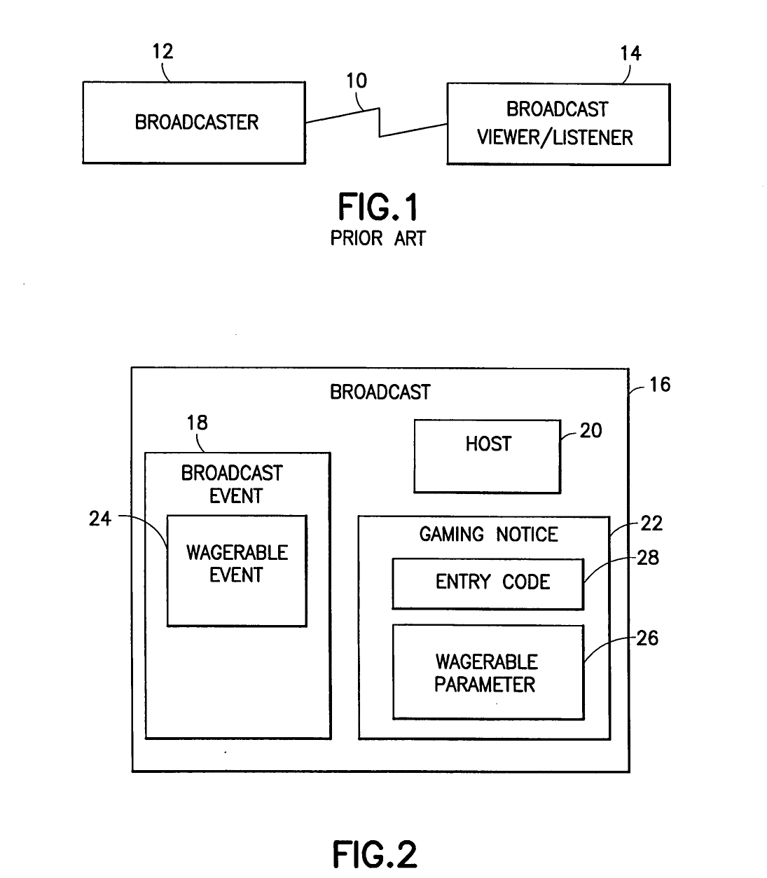

Referring to FIG. 1, there is shown a diagram illustrating a conventional connection 10 between a broadcaster 12 and a broadcast viewer or listener 14. For simplicity, the broadcast viewer or listener 14 will merely be referred to hereinafter as a broadcast viewer 14. The broadcaster 12 can be any suitable type of broadcaster of a live broadcast, such as a television broadcaster, a radio broadcaster, an Internet webcast broadcaster, etc. The broadcast can include any suitable type of live or real-time event, such as a sports competition, a game show, an election, etc. The connection 10 can be any suitable type of connection, such as through the Internet, through a wireless connection, through a television cable network, through a telephone line, through a satellite, or through wireless over-the-air television or radio transmissions for example. As used herein, “broadcast” is intended to include any electronic delivery system or method that delivers content to a viewer/listener including radio, television and the Internet. The broadcast viewer has suitable electronic equipment for viewing and/or listening to the broadcast such as a television, a computer with a display, an AM/FM radio receiver, a handheld webcast receiver, etc.

Referring also to FIG. 2, the broadcast 16 generally comprises a live broadcast event 18. The broadcast 16 can also include a host 20 and one or more gaming notices 22. The live broadcast event 18 can include any suitable type of live or real-time event, such as a sporting event, a game show, an election, etc. For example the sporting event could be a football game, a baseball game, a basketball game, a horse race, etc. As is known in the gaming industry, live broadcast events can form wagerable events 24. For example, wagerable events for a football game can include the final score or outcome of the football game, the first team to score in the football game, the identity of the leading team or score at the end of the first quarter of play, the identity of the player making the first interception, or to first score a sack or touchdown, etc. These are only some examples. There are many different wagerable events in different types of live broadcast events. For a series of broadcast events, such as multiple games in a baseball world series for example, wagerable events also exist such as which team will be the first to win four games, or which team will score the most runs during the series, etc.

As with most live broadcast events, at least one host 20 is usually provided. The host 20 could be part of the broadcast event, such as a host in a game show. However, the host could be separate from the broadcast event, such as an announcer of a football game. The host is normally a person, but could be a computer program.

The gaming notice 22 comprises information to enable the broadcast viewer 14 to enter a gaming entry or wager regarding the wagerable event. The gaming notice 22 can comprise, for example, identification of wagerable parameters 26 and an optional entry code or password 28. For example, in practicing the invention a gaming control authority (such as the broadcaster, or an advertiser, or a broadcast event owner, etc.) may wish to limit wagerable events to only a limited number of predetermined wagerable event(s). For example, the predetermined wagerable event(s) could comprise only the final outcome of a sporting event. As another example, the predetermined wagerable event(s) could comprise only final outcomes of individual games in a baseball world series and identification of a world series champion of the series. The identification of wagerable parameters 26 can identify exactly which wagerable event can be wagered on by the broadcast viewer. The identification of wagerable parameters 26 is preferably part of the broadcast 16, but could be separate from the broadcast, such as advertised in a magazine (TV GUIDE for example) or at an Internet web site, or previous advertisements mentioning the broadcast event for example.

It should be understood that any result, score or performance by a league, team or individual contestant (whether human or animal or machine) may be the object of a wager. For example, the distance of a broad-jump, the time of a sprint, the sequence of teams crossing the finish line in a relay race, the distance of a discus throw or the identify of the winner of the Olympic gold metal winner in a specified event. These are only exemplary examples.

The optional entry code or password 28 is preferably identified in the broadcast 16, but could be separate from the broadcast, such as advertised in a magazine (TV GUIDE for example), or at an Internet web site, or previous advertisements mentioning the broadcast event for example. The code 28 could be announced by the host, or perhaps merely displayed on the display 32 such as in a banner. The code 28 could be in an advertisement of a product or service that is advertised during the broadcast event. The code or password 28 could be used as a verifying parameter of a wager to verify the identity of a wagering party or verifying that a wagering party has been viewing/listening to the broadcast 16. More than one code or password could be provided with the broadcast; perhaps at different times during the broadcast for example.

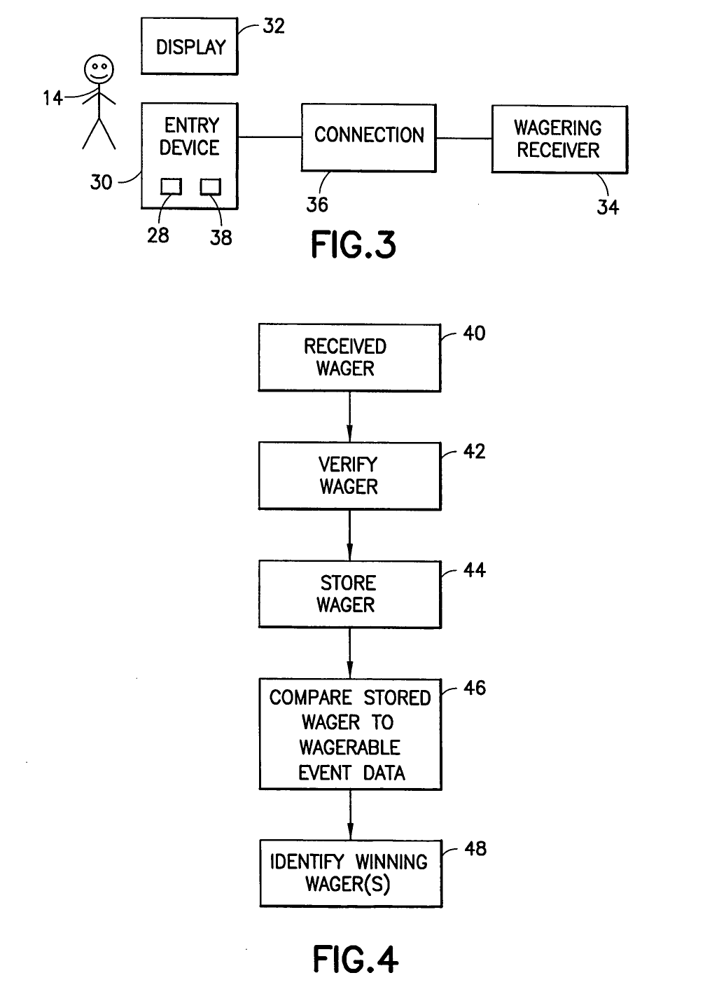

Referring now also to FIG. 3, the broadcast viewer 14 can become a wagering party by entering a wager or gaming entry 38 into an electronic entry device 30. The entry device 30 could comprise, for example, a home computer, or a remote control for a television cable or satellite box, or a mobile communications handset having wireless Internet capability, or a specialized gaming entry device connected to a telephone line or a television set-top box. The location of the viewer 14 could be at the viewer's home, or a gaming outlet such as an OTB (Off Track Betting) outlet, or any other location remote from the location of the broadcast event. Alternatively, or additionally, the location of the viewer 14 could be in the live audience of the broadcast event. The location of the viewer preferably comprises a display 32 such as a computer monitor, or a television set, or a display on a handheld mobile communications device for example.

The entry device 30 is connectable to a wagering receiver 34 by means of a connection 36. The connection 36 could comprise any suitable type of communications connection, such as for example the Internet, a telephone connection, transmission through a television cable system or satellite system, etc. The wagering receiver 34 preferably includes a computer including a memory and a processor or controller, as well as suitable application software. The wagering receiver 34 could be at the broadcaster 12, or at an advertiser, or at a wagering control authority, or any other suitable location.

The wager 38, unlike a conventional “bet” does not comprise a financial risk to the wagering party 14. However, the wager 38 does comprise an award or reward if the wager is a winning or correct wager; such as a monetary award or a product or service award. For example, if a wagering party 14 enters the wager 38 in the entry device 30 that team “A” will beat team “B” in a sporting event, this wager 38 will not involve a financial risk by the wagering party 14. If the wager is not correct, the wagering party will not have placed a winning wager (it will be a loosing wager) and the wagering party will not win anything. However, the wagering party will not financially lose anything either. If the wager is correct, the wagering party can be awarded a prize for having the winning wager. The revenue for the prize(s) can come from advertisers or other revenue sources relating to the broadcast event or the broadcast. Net revenue might increase to the broadcaster or broadcast event owner or revenue control authority from a surcharge gaming fee charged to the advertiser(s). However, one of the principal features of the invention is to attract larger audiences to the broadcast through the gaming aspect of the invention. This will allow advertisers to have greater audiences for their advertisements. With greater size audiences for. broadcasts, this allows the broadcaster to charge larger fees to broadcast advertisements based upon the larger size audiences as is generally known in the industry.

Referring also to FIG. 4, the wagering receiver 34 is adapted to receive 40 the wager 38 and its computer is adapted to verify 42 the wager 38 and store 44 the wager in a memory. Verification of the wager could occur after storage or after identification of winning wager(s). The verification can comprise, for example, identification of a broadcast viewer who is authorized to wager, verification that an entry code in the wager matches an authorized entry code 28, and/or verification of a wager entry time versus an authorized wager entry time range. In one type of embodiment, the wager 38 will need to be entered and communicated to the wagering receiver 34 before the start of the broadcast event 18. However, the entry code 28 will preferably be communicated only after the broadcast event 18 has started. Thus, there is preferably a second entry by the viewer 14 of the entry code 28 needed to be made during the broadcast event. The entry code 28 is preferably not communicated in the broadcast until some unannounced time during the broadcast, and its entry via the connection 36 might be limited to a predetermined period of time after the communication of the code 28 in the broadcast. This could be used to help promote viewing of the broadcast by the viewer 14, and preventing the viewer from merely entering the wager at the start of the broadcast and then no longer viewing the broadcast. However, any suitable verification of identity or authorization and wagering limitations could be provided.

When the broadcast event is completed, or at least a wagerable event is completed, data regarding the wagerable event(s) are compared by the computer to the stored wager(s) as indicated by block 46. The computer is able to then identify winning wager(s) as indicated by block 48. After identifying winning wager(s), the computer (or perhaps at least one other computer) can determine how to award a winning wager and perhaps the amount or type of award to be given.

The amount or type of the award might be pre-established. For example, the award could be a fixed dollar amount, such as $5.00 or $100.00, or could be a fixed product or service award, such as a free case of COKE COLA® or a free meal at McDONALDS®. The amount of the award might also be variable based upon any number of gaming variables relating to the broadcast event, such as win, place or show positions of horses in a horse race for example.

Referring also to FIG. 5, in one embodiment determining 49 the award amount for a winning wager can include determining 50 at least a portion of revenue obtained from the broadcast and/or broadcast event to be allocated or apportioned for winning wager awards, and determining 52 the number of winning wager(s) which that revenue portion is to be apportioned among. Determining 52 the number of winning wager(s) which that revenue portion is to be apportioned among might be “1” if there was only one winning wager, or “0” if there were no winning wagers. The apportioning might not be equal among winning wagers, such as different amount for win, place or show positions of horses in a horse race for example.

In one embodiment, the step of determining 50 at least a portion of revenue obtained from the broadcast and/or broadcast event to be allocated or apportioned for winning wager awards can include determining 54 an audience rating and having an advertiser pay a fee based upon that audience rating. The audience rating could be a NIELSEN® household rating for example. For example, the advertiser could be obligated to pay a higher fee for a broadcast having a NIELSEN® rating of 18 and a lower fee for a broadcast having a NIELSEN® rating of 15. A household Rating is the estimate of the size of a television audience relative to the total universe, expressed as a percentage. As of Sep. 26, 2005, there are an estimated 110.2 million television households in the United States of America. A single national household ratings point represents 1 percent, or 1,102,000 households. However, any suitable audience rating could be used.

This merely illustrates that the invention can comprise obtaining greater revenue for winning wager(s) when the audience size is greater, and having advertisers pay less for winning wager(s) when the audience size is smaller. However, in an alternate embodiment, the fees paid by advertisers might not change based upon an audience rating. Rather than the broadcaster running the wagering/gaming system, one or more advertisers who run advertisements during the broadcast could run the wagering/gaming system, such as when its/their advertisement(s) have the code(s) 28. Thus, a wagering party might be able to have his/her wager entered and assessed by multiple advertisers and receive multiple awards/winnings for each winning wager; one from each participating advertiser for example.

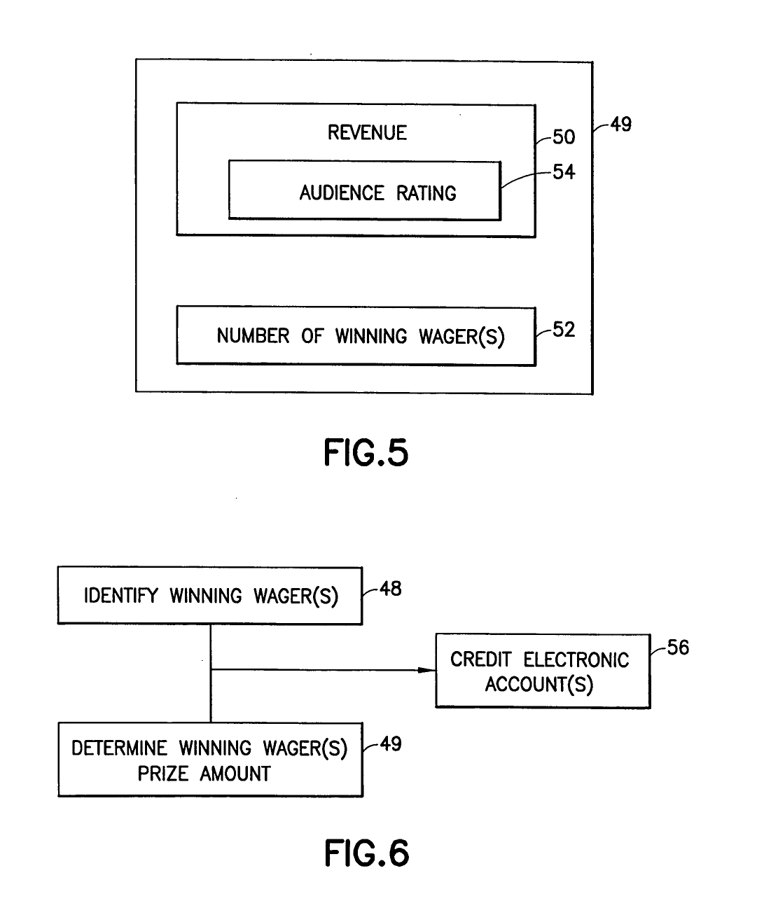

Referring also to FIG. 6, after winning wager(s) have been identified as indicated by block 48 and after winning wager prize amounts have been determined as indicated by block 49, the wagering control authority is able to electronically credit the award/winning into respective electronic account(s) for the winning wagering party(ies) as indicated by block 56. This could be done, at least partially, by the computer of the wagering receiver for example. The winning wagering party(ies) can subsequently redeem the award/winning in any suitable manner. The memory(ies) can be adapted to store electronic signal instructions from the host or other controlling party governing the determination and evaluation of winning wagers (i.e., the size and nature of a prize won by a winning wagering party).

The invention can provide a method and system for prize funding. A method can be provided for funding prizes awarded to members of audiences of television, radio, Internet or other broadcast stations, who have successfully wagered by acceptably predicting the result, score or other outcome of an event, including a sports-related event, or sub-event thereof, the outcome of which is not known until the completion of such an event. The method can be characterized by:

(a) creating prize funds stemming essentially from revenues derived from fees paid to stations by advertisers pursuant to agreements providing for the promotion of advertisers' products or services on programs carried by the stations and featuring the events,

(b) stations giving individually identified audience members the opportunity at essentially no risk or cost to wager on the outcome of at least one such event or sub-event by entering a prediction of the outcome of such an event in an entering device for transmission of the prediction to a central wager evaluation facility, the central facility comprising means for receiving electronic signals from members' remote locations conveying wager information, means for receiving a host's evaluation and scaling criteria and comparison circuitry for comparing members' entered wagers with the evaluation criteria to determine winning members and their prizes in accordance with the scoring criteria,

(c) the event or events having been selected and announced to audience members by a station host, and

(d) provisions in the agreements between stations and advertisers, which relate the size of the promotional fees paid to stations by advertisers to the ratings of such programs offering wagering opportunities.

Higher program ratings, resulting from a larger number of audience members being tuned to such higher rated programs, can generate larger fees paid to stations by advertisers whose products or services are promoted on the programs. The stations, the members' entering devices wager transmitting means, and the central facility can form an interconnected system. The method can comprise limiting the number of wagers received and accepted for evaluation for each selected event and transmitted from the entering devices to the central facility via the Internet, the number of accepted wagers being the number of first-received wagers announced by a station host.

Accounts can be established and maintained for each identified wagering member, the accounts being adapted to keep running up-to-date information relating to prizes awarded to individual winning members, the accounts being adapted to permit members to access their accounts for the purpose of ascertaining the status of their individual accounts or prize score of each member. The system can further include facilities at remote locations at which winning members may redeem prize or vouchers or receive cash or merchandise prizes. Prizes may also have symbolic value, such as PEP messages.

The method can include limiting the number of wagers relating the specific event and entered by members identified by a code or password to a number of wagers determined and announced by a station host. The method can include the entering device transmitting electronic signals conveying wager information on a fixed frequency and wherein the receiving means for electronic signals conveying wager information at the central facility receive the electronic signals on the fixed frequency.

The method can include a station host selecting and announcing at least one event or sub-event on which audience members may wager, whereas the host provides winning wager and scoring criteria for each event or sub-event and wherein a winning member having acceptably wagered on the outcome of a selected event or sub-event is rewarded with a prize. The method or system can include the entering device comprising a plurality of function keys, which, when pressed, transmit a function or wager instruction to the central facility.

The term sub-event is intended to include the meaning of partial events such as, for example, a quarter in a football game, the mid-stream score or result in a contest such as the half-time score in a basketball game, the point score after six rounds of a boxing bout, the score after two sets of tennis, a golfer's number of strokes after the third hole or a batter's number of hits at the end of the 7th inning of a baseball game or the name of the football player having achieved the first intercept. The term sub-event is also intended to include the performance, acts or achievements of a contestant or participant in a contest or event such as the result achieved by a high jumper, a broad jumper, a pole vaulter, a discus thrower and the like. The term sub-event also is intended to include the results of a sprint, of a hurdle race, a long-distance race or swimming heat, including performances by individuals or teams.

Contests on which audience members may wager are intended to include all kinds of contests such as the outcome of elections. Events, the outcome of which audience members may predict, are intended to include events which are not contests such as, for example, the maximum temperature in a certain geographic area or the mean per capita income in a geographic area for a specified time period.

Features of the invention can be embodied in the entry device 30, such as a specialized entry device or software programming of a television set-top box for example. Features of the invention can be embodied in specialty software in the computer or broadcast equipment of the broadcaster and/or the computer of the wagering receiver.

Although the invention has been described with reference to the exemplary embodiment shown in the drawings, it should be understood that the invention can be embodied in many alternate forms of embodiments. It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A method for providing a wagering system regarding at least a partial result in at least one broadcast event, the method comprising:
determining a prize payout amount for a winning wager based, at least partially, upon an audience rating of the broadcast event; and
crediting the prize payout amount to an electronic account of a wagering party having the winning wager, wherein the winning wager did not include a financial risk by the wagering party.

2. A method as in claim 1 further comprising contracting by a broadcaster of the broadcast event with an advertiser for payment of a fee by the advertiser for broadcast of an advertisement by the broadcaster during the broadcast event, wherein an amount of the fee is determined, at least partially, based upon an audience rating of the broadcast event.

3. A method as in claim 2 further comprising:
receiving the payment of the fee from the advertiser at least partially after broadcast of the broadcast event; and
allocating the fee to electronic accounts of wagering parties who placed a winning wager regarding the broadcast event.

4. A method as in claim 1 further comprising:
entering the wager by the wagering party into an electronic communication device without a financial risk by the wagering party, wherein the wager is based, at least partially, upon an outcome of the broadcast event; and
electronically communicating the wager to a broadcaster of the broadcast event.

5. A method as in claim 4 wherein electronically communicating the wager to the broadcaster or central evaluation facility comprises transmitting the wager over the Internet.

6. A method as in claim 4 wherein electronically communicating the wager to the broadcaster or central evaluation facility comprises transmitting the wager over a television cable connection.

7. A method as in claim 1 wherein determining the prize nature and payout amount comprises comparing by a computer a wager made by the wagering party to scoring criteria.

8. A method as in claim 1 further comprising determining a winning status of a wager comprising entering at least one winning criteria into a computer.

9. A method as in claim 1 further comprising:
providing a system for electronically entering wagers of the wagering parties into a computer; and
limiting a number of the wagers which can be entered into the computer.

10. A method as in claim 9 wherein limiting the number of the wagers which can be entered into the computer is adapted to limit a number of wagers by each respective wagering party.

11. A method as in claim 9 wherein limiting the number of the wagers which can be entered into the computer is adapted to limit a number of cumulative wagers by one or all wagering parties.

12. A method as in claim 9 wherein limiting the number of the wagers which can be entered into the computer is adapted to limit the entry of wagers based, at least partially, upon time.

13. A method as in claim 12 wherein limiting the number of the wagers which can be entered into the computer is adapted to limit the entry of wagers based, at least partially, upon a time differential between wagers by a respective wagering party.

14. A method as in claim 9 wherein limiting the number of the wagers which can be entered into the computer is adapted to limit the entry of wagers by each wagering party to only one wager for each wagering party on a wagerable event.

15. A method as in claim 1 wherein a host in the broadcast event announces at least one wagerable event which the wagering party may wager on during the broadcast event.

16. A method as in claim 1 wherein the broadcast event communicates a password or code required to verify a wager by the wagering party.

17. A method as in claim 16 further comprising limiting entry of a wager by the wagering party based, at least partially, upon time.

18. A method of providing a wagering system regarding at least a partial result in at least one broadcast event, the method comprising:
contracting by a broadcaster of the broadcast event with an advertiser for payment of a fee by the advertiser for broadcast of an advertisement by the broadcaster during the broadcast event, wherein an amount of the fee is determined, at least partially, based upon an audience rating of the broadcast event;
receiving the payment of the fee from the advertiser at least partially after broadcast of the broadcast event; and
allocating the fee to electronic accounts of wagering parties who placed a winning wager regarding the broadcast event.

19. A method of wagering comprising:
entering a wager by a wagering party into an electronic communication device without a financial risk by the wagering party, wherein the wager is based, at least partially, upon an outcome of a broadcast event; and
electronically communicating the wager to a broadcaster of the broadcast event.

20. A method of wagering comprising:
providing a broadcast viewer an ability to wager regarding at least a partial result of at least one broadcast event, wherein the wager does not include a financial risk by the broadcast viewer; and
depositing an electronic credit into an account for the broadcast viewer based upon a winning wager by the broadcast viewer.
